(19) United States
(12) Patent Application Publication
(10) Pub. No.: US 2023/0374213 A1
(43) Pub. Date: Nov. 23, 2023

(54) PROCESS FOR PREPARING BRANCHED PHENOLIC NOVOLAK

(71) Applicant: Advanced Polymer Coatings, Inc., Avon, OH (US)

(72) Inventor: Jeremy Pasatta, Olmsted Falls, OH (US)

(73) Assignee: Advanced Polymer Coatings, Inc., Avon, OH (US)

(21) Appl. No.: 18/030,301

(22) PCT Filed: Oct. 5, 2021
(86) PCT No.: PCT/US2021/071715

§ 371 Date: Apr. 5, 2023

Related U.S. Application Data
(60) Provisional application No. 63/198,223, filed on Oct. 5, 2020.

(51) Int. Cl. C08G 65/38; C08L 71/12

(52) U.S. Cl. CPC C08G 65/38; C08L 71/126

(57) ABSTRACT

A process for synthesizing a branched phenolic novolak using commercially available raw materials, amenable to large scale manufacturing, and giving good chemical resistance when used in epoxy formulations is described. When combined with resorcinol during the epoxy synthesis, the branched phenolic novolak gives superior chemical resistance in a two-component heat cured epoxy.

This application claims the benefit of U.S. Provisional Application Ser. No. 63/198,223, filed Oct. 5, 2020, and titled “PROCESS FOR PREPARING BRANCHED PHENOLIC NOVOLAK,” the entirety of which is hereby expressly incorporated by reference herein.

### BACKGROUND

The present exemplary embodiment relates to a process for preparing a branched phenolic novolak. The branched phenolic novolak may exhibit molecular weight and molecular weight distribution properties making it particularly suited for use in chemically resistant epoxy linings. It finds particular application in two-component heat cured epoxy linings exhibiting high chemical resistance and will be described with particular reference thereto. However, it is to be appreciated that the present exemplary embodiment is also amenable to other like applications.

Production of a branched phenolic novolak is known in the field. U.S. Pat. No. 7,371,800 describes a process of preparing a branched phenol novolak from 4-hydroxylphenylmethylcarbinol. The process begins with the hydrogenation of 4-hydroxyacetophenone (4-HAP) to obtain 4-hydroxyphenylmethylcarbinol (4-HPMC). This process adds cost and additional processing time to the synthesis. 4-HPMC is then subjected to a catalyst and converted to 4-hydroxyphenylmethylcarbinol methyl ether, which is then polymerized using an acid catalyst to form the branched phenolic novolak. U.S. Pat. No. 7,371,800 also describes dilution of the polymer in methanol, with subsequent precipitation in water as an isolation method. U.S. Pat. No. 4,468,507 describes a process for preparing a branched phenolic novolak starting from readily available raw materials. U.S. Pat. No. 4,468,507 more specifically attempts to limit oligomer content. U.S. Pat. No. 4,468,507 also does not describe what raw materials are best utilized for chemically resistant linings. Furthermore, methods of polymer isolation useful in production processes are not described. U.S. Pat. No. 6,180,723 describes a process for producing an epoxy functional branched phenolic novolak through the reaction of the branched phenolic novolak with epichlorohydrin in the presence of a catalyst, and subsequently performing dehydrohalogenations, and finally removal of unreacted epichlorohydrin and solvent through vacuum distillation. It is desirable to perform these reactions based on a branched phenolic novolak that has an optimized pricing, supply of raw materials, and coating properties.

It would be desirable to develop new branched phenolic novolaks that utilize commercially available and inexpensive raw materials that when synthesized into a branched phenolic novolak give excellent chemical resistance in a two-component heat cured epoxy lining. It is also desirable to target a specific molecular weight of branched phenolic novolak that was converted into epoxy and used in a two-component heat cured epoxy lining gives acceptable coating properties, in particular viscosity and cure time. Furthermore, it is desirable to have a production method that is easy to operate using standard production equipment.

### BRIEF DESCRIPTION

A branched phenolic novolak is produced with a molecular weight suitable for an epoxy resin used for chemically resistant coatings. The branched phenolic novolak is produced from commercially available raw materials by a process that is amenable to large scale production.

The process may include reacting a diphenol compound with formaldehyde to form a compound comprising methylol functional groups and reacting the compound comprising methylol functional groups with o-cresol to form the branched phenolic novolak.

The branched phenolic novolak may have a number average molecular weight between about 1,500 Da and about 3,000 Da, including from about 2,000 Da to about 3,000 Da.

In some embodiments, the branched phenolic novolak has a weight average molecular weight between about 2,000 Da and about 8,000 Da, including from about 3,000 Da to about 6,000 Da.

The branched phenolic novolak may have a polydispersity index between about 1.1 and about 3.0, including from about 1.3 to about 2.2.

The diphenol compound may be bisphenol F and the compound with methylol functionality may be tetramethylol bisphenol F.

The diphenol compound and formaldehyde may be reacted in the presence of a catalyst such as sodium hydroxide.

In some embodiments, the reaction of the diphenol compound and formaldehyde occurs at a temperature in the range of about 30° C. to about 50° C., including from about 35° C. to about 45° C.

The reaction of the diphenol compound and formaldehyde may be performed in a reactor comprising from about 3.5 to about 6 moles formaldehyde per mole of the diphenol compound, including from about 4 to about 5 moles formaldehyde per mole of the diphenol compound.

In some embodiments, the reaction of the compound comprising methylol functional groups with o-cresol is performed in a reactor comprising about 2 to about 6 moles o-cresol per mole of the compound comprising methylol function groups, including from about 3 to about 5 or amount 3.5 to about 4.5 moles o-cresol per mole of the methylol-functionalized compound.

Processes for preparing an epoxy resin are also disclosed. The processes generally include reacting the branched phenolic novolak with resorcinol and epichlorohydrin.

Further disclosed are processes for applying a coating. The processes include depositing a coating composition containing the epoxy resin, a solvent, and optionally suitable additive(s) along with a curative onto a substrate, evaporating the solvent, and curing the epoxy resin.

Branched phenolic novolaks, epoxy resins, coatings, and coated articles as described herein are also disclosed.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a flow chart illustrating a non-limiting example of a method for producing a branched phenolic novolak in accordance with some embodiments of the present disclosure.

FIG. 2 is a flow chart illustrating a non-limiting example of a method for producing a coating in accordance with some embodiments of the present disclosure.

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The present disclosure relates to a process for preparing a branched phenolic novolak.

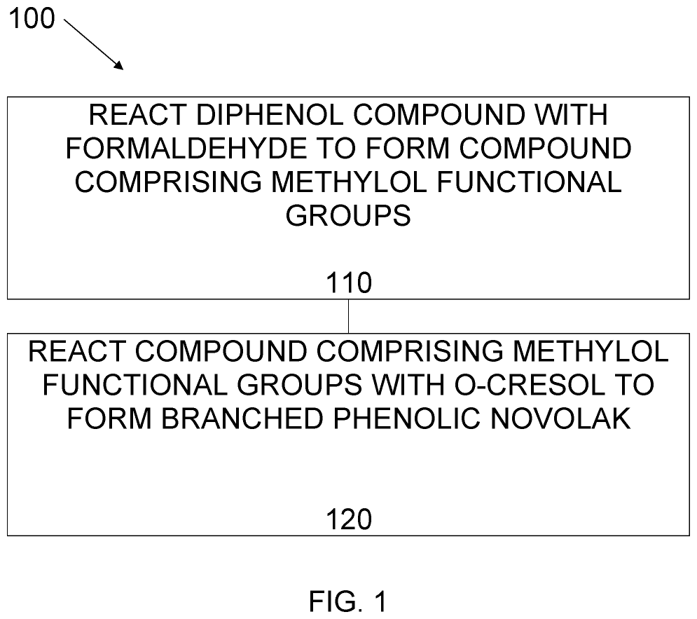

FIG. 1 illustrates a non-limiting process 100. The process 100 includes reacting a diphenol compound with formaldehyde to form a compound comprising methylol functional groups 110 and reacting the compound comprising methylol functional groups with o-cresol to form the branched phenolic novolak 120.

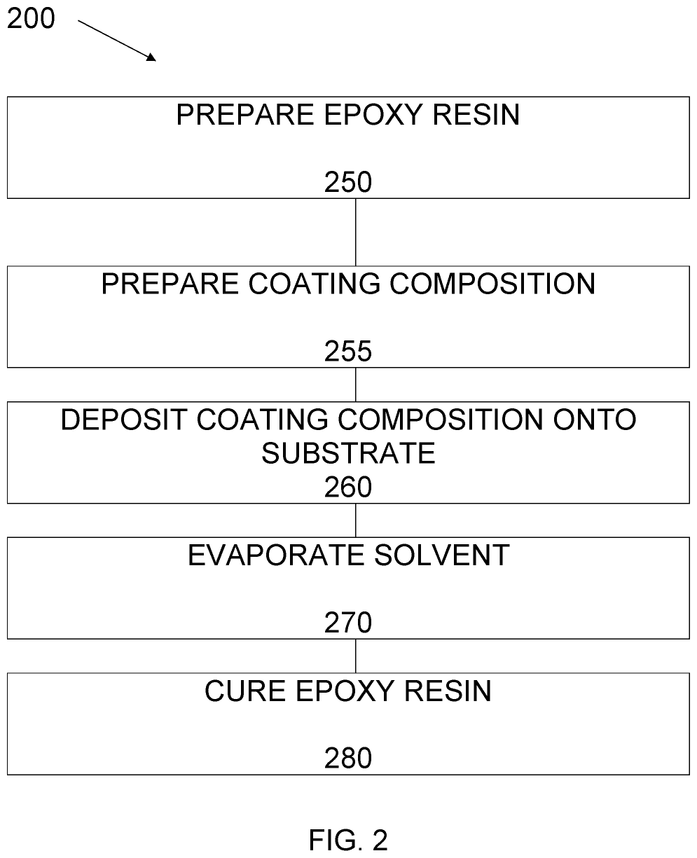

FIG. 2 illustrates a non-limiting process for forming a coating 200. The process includes preparing an epoxy resin 250, combining the epoxy resin, solvent and additives with a curative to form a coating composition 255, depositing the coating composition comprising the epoxy resin, curative, additives and a solvent onto a substrate 260, evaporating the solvent 270, and curing the epoxy resin 280. In some embodiments, the preparation of the epoxy resin 250 includes reacting the branched phenolic novolak produced in FIG. 1, resorcinol, and epichlorohydrin.

The branched phenolic novolak described herein is produced through the reaction of commercially available raw materials. The synthesis begins with the formation of tetramethylol bisphenol F. Tetramethylol bisphenol F (TMBPF) may be formed through the reaction of bisphenol F in water with sodium hydroxide and 37% formaldehyde at a reaction temperature of 40° C. Sodium hydroxide is used as the catalyst in the reaction between bisphenol F and formaldehyde, and forms the diphenolate ion of bisphenol F, which facilitates the reaction between bisphenol F and formaldehyde. It will be recognized that any catalyst capable of forming the diphenolate ion or otherwise catalyzing the reaction between bisphenol F and formaldehyde may be substituted for sodium hydroxide. One skilled in the art can recognize that other diphenols can be substituted for bisphenol F, such as bisphenol A, bisphenol M, hydroquinone and other similar such compounds. Bisphenol F is preferred because bisphenol F is known in the industry to give better chemical resistance compared to epoxy resin based in bisphenol A. It should be recognized that any diphenol capable of undergoing reaction with formaldehyde using a base as a catalyst can be used in this disclosure. This reaction may be performed at a stoichiometry of 4.25 moles of formaldehyde for 1 mole of bisphenol F. The reaction may be performed at a stoichiometric excess of bisphenol F compared to formaldehyde to ensure that 4 methylol groups are added per molecule of bisphenol F. The preferred stoichiometry is 3.5 to 6 moles of formaldehyde to bisphenol F, and the most preferred stoichiometry is 4 to 5 moles of formaldehyde to bisphenol F. The reaction may be performed at elevated temperatures, preferably between 30 and 50° C., and most preferably between 35 and 45° C. It will be recognized that other temperature ranges sufficient to allow for the reaction to occur can be used. After this reaction is complete, o-cresol is added, the solution is neutralized with hydrochloric acid, methanol is added to control reaction viscosity. Optionally, methanol can be added to lower reaction viscosity. O-Cresol was chosen for this reaction because it is known in the industry to produce structures with superior chemical resistance compared to the other isomers of cresol. The stoichiometry of o-cresol to TMBPF may be critical for controlling molecular weight. It was found that a ratio of about 1.1 moles of o-cresol for about 0.22 moles starting bisphenol F is the optimum ratio. The reaction between o-cresol and TMBPF may occur at the reflux temperature of the reaction mixture, but it will be recognized by one skilled in the art that other temperatures lower than the reflux temperature that allow the reaction between o-cresol and TMBPF to proceed can be used. After the reaction is complete, additional methanol is added to produce a very low viscosity polymer solution that is amenable to be poured into an excess of water for precipitation. After the reaction is complete and before precipitation, the reaction is neutralized (e.g., with 50% sodium hydroxide in water) and brought to slightly acidic conditions (e.g., with 75% acetic acid in water). The reaction is then precipitated in a large excess of water, filtered and isolated for further use. Optionally, after reaction is complete and before precipitation, all volatiles can be removed by heating the reaction under vacuum. The isolated molten polymer is then sent to suitable equipment for isolation, such as a drum flaker. The finished polymer should have a molecular weight suitable for use in an epoxy resin for chemically resistant coatings. If the molecular weight is too high and the polydispersity index is too broad, the epoxy resin viscosity will be high and will be difficult to use. Conversely, if the molecular weight is low and the polydispersity is narrow, this is an indication that there was little to no coupling of TMBPF molecules, and this lack of bridging between TMBPF molecules can lead to less chemical resistance. The preferred molecular weight as measured by GPC is an Mn of 1500 to 3500 Daltons, with a most preferred range between 2000 and 3000 Daltons, an Mw of 2000 to 8000 Daltons, with a most preferred range between 3000 and 6000 Daltons, and a polydispersity index between 1.1 and 3.0, with a most preferred range between 1.3 and 2.2.

The following examples are provided to illustrate the devices and methods of the present disclosure. The examples are merely illustrative and are not intended to limit the disclosure to the materials, conditions, or process parameters set forth therein.

### EXAMPLES

### Example 1: Synthesis of Branched Phenolic Novolak

20 to 60 g of bisphenol F, 50 to 110 g of distilled water and 20 to 40 g of 50% by weight sodium hydroxide in water are weighed into a clean, three neck one-liter round bottom flask equipped with a water cooled condenser, nitrogen inlet and outlet, and magnetic stirring. The slurry is stirred at ambient for approximately 30 minutes. After the 30-minute period, 50 to 100 g of 37% by weight formaldehyde in water is added and the resultant mixture is heated to 40° C. The mixture is held at 40° C. with stirring a slow nitrogen purge for 16 hours. After the 16 hour hold period, 100 to 140 g of o-cresol is added, and the solution is neutralized and brought to slightly acidic with concentrated hydrochloric acid. 50 g of methanol are added, and the solution temperature is raised to allow for reflux, and the solution is allowed to reflux for approximately 1.5 hours. After the reflux period is complete, the reaction temperature is lowered to room temperature, and 400 grams of methanol are added with stirring. Once the reaction has reached ambient, the solution is neutralized with 50% by weight sodium hydroxide, and then brought to a slightly acidic pH with 75% by weight acetic acid. At this point, the reaction separates into two phases, and the brine layer is separated and discarded. The remaining product layer is slowly dripped into a large excess of water and precipitated from solution. The precipitate is then washed several times with water and allowed to dry at ambient for approximately two days at ambient, forming a loose powder wet cake. The final product is a beige solid powder with Mn of approximately 2600 Daltons, Mw of approximately 4700 Daltons and Polydispersity Index (PDI) of 1.81.

### Example 2: Synthesis of Epoxy Resin Containing Example 1

An epoxy resin containing the branched phenolic novolak and resorcinol was synthesized for use in chemically resistant two-component heat cured epoxy lining. 70 to 110 grams of resorcinol and 20 to 40 g branched phenolic novolak from Example 1 were weighed into a clean three neck 1 liter round bottom flask equipped with an addition funnel, water cooled condenser, and nitrogen inlet and outlet. To this flask, epichlorohydrin was added in a molar ratio of epichlorohydrin to hydroxyl groups ranging from 1 to 5. Catalyst was also added to the reaction flask. Any catalyst suitable for catalyzing the reaction between hydroxyl group and epichlorohydrin can be used, including but not limited to octadecylbenzyl ammonium chloride, benzyltrimethyl ammonium chloride and other quaternary ammonium salts. The temperature was raised to 59° C. with stirring and a slow nitrogen purge. Once the mixture was at reaction temperature, 25% caustic in water was added using the addition funnel. Other suitable caustics can be added to the reaction, including but not limited to potassium hydroxide, calcium hydroxide and sodium hydroxide. After the 20-minute addition period, the reaction was held at approximately 60° C. for 1.5 hours with stirring and a slow nitrogen purge. Additional 25% caustic in water was then added over a 20-minute period, and the reaction was held at approximately 60° C. for 1.5 hours. Additional 25% caustic in water was then added using the addition funnel and held at 60° C. for approximately 1.5 hours. After the 1.5 hold period, the reaction was poured into a separatory funnel and allowed to phase separate for at least 30 minutes, after which time the waste layer was decanted and discarded and the product layer was returned to the 1 liter three necked round bottom reaction flask. The flask was equipped again with an addition funnel, nitrogen inlet and outlet and magnetic stirring. The reaction temperature was brought back to 60° C., and once at reaction temperature, catalyst was added, and then additional 25% caustic in water was added was added. The reaction was held at 60° C. for 1.5 hours, after which time it was poured into a separatory funnel and allowed to phase separate for a minimum of 30 minutes. After the 30 minutes, the waste layer was decanted and disposed of, and the product layer was returned to the 1 liter three necked round bottom reaction flask. The flask was equipped again with an addition funnel, nitrogen inlet and outlet and magnetic stirring. The reaction temperature was brought back to 60° C., and once at reaction temperature, catalyst was added, and then additional 25% caustic in water was added was added. The reaction was held at 60° C. for 1.5 hours, after which time it was poured into a separatory funnel and allowed to phase separate for a minimum of 30 minutes. After the phase separation time was complete, the waste layer was decanted and discarded, and the product layer was returned to the one liter three necked round bottom reaction flask equipped with magnetic stirring. The reaction temperature was set at 40° C., and a suitable buffer in water was added, and the flask was capped. The reaction was stirred for a minimum of 20 minutes, after which time the reaction was transferred to a separatory funnel and allowed to phase separate for a time period of at least 30 minutes. After the 30-minute time period, the waste layer was decanted and discarded, and the product layer was returned to the one liter three neck round bottom reaction flask equipped with magnetic stirring. The reaction temperature was set to 40° C., and water was added while the reaction was stirring. The reaction was allowed to stir for at least 20 minutes, after which time the reaction was poured into a separatory funnel and allowed to phase separate for a period of at least 30 minutes. After the 30-minute phase separation period, the waste layer was decanted and discarded and the reaction was returned to the one liter, three neck round bottom flask, equipped with magnetic stirring and set up for vacuum distillation. The temperature was set to 120° C., and vacuum distillation at full vacuum was conducted until visible degassing had ceased. After vacuum distillation was complete, the final product was poured into a suitable contained and measured for epoxy equivalent weight (EEW), viscosity and relative composition percent by gel permeation chromatography (GPC). The epoxy resin had an EEW 135, viscosity of 2240 cP at 77° F. as measured by a Brookfield DVTII+, spindle number 5 at 50 RPM, and approximately 55 to 65% monomeric resorcinol diglycidyl ether and 15 to 25% of epoxy functional Example 1. The GPC was measured on a Shimadzu GPC, RID-10A detector, 35° C. column temperature, three Varian GPC/SEC Mesopore 300×7.5 mm columns, P/N 1113-6325 using inhibited tetrohydrofuran at a flow rate of 1 m l/m in.

### Example 3. Chemical Resistance of Example 2

The epoxy produced in Example 2 was catalyzed with an amine catalyst comprising a mixture of a cycloaliphatic amine and imidazoles at the stoichiometric level of amine to epoxy. The catalyzed mixture was poured into molds and allowed to cure at ambient for 24 hours, after which time it was cured at 121° C. for 6 hours. After this time the castings were allowed to cool to room temperature, removed from the molds, and cut into appropriately sized samples for chemical immersion testing. As a reference, a similar epoxy to that of Example 2 was made, substituting the branched phenolic epoxy of Example 1 for a commercially available branched phenolic novolak. The comparative epoxy was catalyzed and cured under the same conditions. Cut casting pieces were rinsed with distilled water and immersed in the chemicals specified in Table 1 at the conditions specified in Table 1. Samples were removed weekly, rinsed with distilled water, allowed to dry for a minimum of 2 hours at ambient and then weighed for weight gain or loss. After the samples were weighed, they were placed back in the immersion chemicals. After 35 days immersion, the cured epoxy using the branched phenolic novolak from Example 2 had similar, if not less, weight gain in all immersion chemicals tested.

35 Days Immersion

| | | Comparative | |
|---|---|---|---|
| Epoxy | | Example | Example 2 |
| | Immersion Temp | Weight | Weight |
| Immersion Chemical | (° C.) | gain (%) | Gain (%) |
| Methanol | 40 | 3.5% | 3.3% |
| Methanol | 55 | 5.5% | 4.9% |
| 13% sodium hypochlorite | 25 | 0.5% | 0.5% |
| Methylene chloride | 25 | 1.5% | 1.4% |
| 100% Acetic acid | 40 | 1.7% | 1.6% |
| 85% Phosphoric acid | 25 | 0.7% | 0.5% |
| 37% Hydrochloric acid | 40 | 6.0% | 5.4% |
| Sulfuricacid | 40 | 0.1% | 0.2% |
| 90% Phenol | 25 | 1.5% | 0.7% |
| Acyrlonitrile | 25 | 0.5% | 0.5% |

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A process for preparing a branched phenolic novolak comprising:
reacting a diphenol compound with formaldehyde to form a compound comprising methylol functional groups; and
reacting the compound comprising methylol functional groups with o-cresol to form the branched phenolic novolak.

2. The process of claim 1, wherein the branched phenolic novolak has a number average molecular weight between about 1,500 Da and about 3,000 Da.

3. The process of claim 1, wherein the branched phenolic novolak has a number average molecular weight between about 2,000 Da and about 3,000 Da.

4. The process of claim 1, wherein the branched phenolic novolak has a weight average molecular weight between about 2,000 Da and about 8,000 Da.

5. The process of claim 1, wherein the branched phenolic novolak has a weight average molecular weight between about 3,000 Da and about 6,000 Da.

6. The process of claim 1, wherein the branched phenolic novolak has a polydispersity index between about 1.1 and about 3.0.

7. The process of claim 1, wherein the branched phenolic novolak has a polydispersity index between about 1.3 and about 2.2.

8. The process of claim 1, wherein the diphenol compound is bisphenol F.

9. The process of claim 1, wherein the compound comprising methylol functional groups is tetramethylol bisphenol F.

10. The process of claim 1, wherein the diphenol compound and formaldehyde are reacted in the presence of a catalyst.

11. The process of claim 1, wherein the catalyst is sodium hydroxide.

12. The process of claim 1, wherein the reaction of the diphenol compound and formaldehyde occurs at a temperature in the range of about 30° C. to about 50° C.

13. The process of claim 1, wherein the reaction of the diphenol compound and formaldehyde occurs at a temperature in the range of about 35° C. to about 45° C.

14. The process of claim 1, wherein the reaction of the diphenol compound and formaldehyde is performed in a reactor comprising from about 3.5 to about 6 moles formaldehyde per mole of the diphenol compound.

15. The process of claim 1, wherein the reaction of the diphenol compound and formaldehyde is performed in a reactor comprising from about 4 to about 5 moles formaldehyde per mole of the diphenol compound.

16. The process of claim 1, wherein the reaction of the compound comprising methylol functional groups with o-cresol is performed in a reactor comprising from about 2 to 6 moles o-cresol per mole of the compound comprising methylol functional groups.

17. The process of claim 1, wherein the reaction of the compound comprising methylol functional groups with o-cresol is performed in a reactor comprising from about 3 to 5 moles o-cresol per mole of the compound comprising methylol functional groups.

18. (canceled)

19. A process for preparing an epoxy resin comprising:
reacting a branched phenolic novolak, resorcinol, and epichlorohydrin; wherein the branched phenolic novolak has a number average molecular weight between about 1,500 Da and about 3,500 Da;
wherein the branched phenolic novolak has a weight average molecular weight between about 2,000 Da and about 8,000 Da; and
wherein the branched phenolic novolak has a polydispersity index between about 1.1 and about 3.0.

20. A process for applying a coating comprising:
depositing a coating composition comprising a solvent, epoxy resin, curative, suitable fillers and additives prepared in claim 19 onto a substrate;
evaporating the solvent; and
curing the epoxy resin.

21. A branched phenolic novolak produced by the process of claim 1.

22-24. (canceled)
